(19) United States
(12) Patent Application Publication
(10) Pub. No.: US 2012/0272222 A1
(43) Pub. Date: Oct. 25, 2012

(54) Software Tool for Automation

(75) Inventor: Rudolf POHLAN, Waldbronn (DE)

(73) Assignee: Siemens Aktiengesellschaft, Muenchen (DE)

(21) Appl. No.: 13/452,170

(22) Filed: Apr. 20, 2012

(30) Foreign Application Priority Data
Apr. 21, 2011 (EP) EP11163488

(51) Int. Cl. G06F 9/45

(52) U.S. Cl. 717/136

(57) ABSTRACT

A software tool for automation having a functionality for output conversion, where a plurality of applications, which are each intended for a dedicated object domain, are or can be combined with the software tool at the same time, each application comprises at least one first software interface for access to the output conversion, and where the output conversion comprises at least one mapping component for conversion of objects from an object domain of the application to an object of an abstract object model which is defined for the output component.

### BACKGROUND OF THE INVENTION

1. Field of the Invention

The invention relates to a software tool for automation and more particularly, to software tools for automation such as planning systems, engineering systems and debuggers.

2. Description of the Related Art

Software tools for automation are known per se. For example, the present inventors provide engineering systems known as STEP that are used for automation to create automation programs for automation appliances, such as programmable logic controllers. One such engineering system, which an end user uses to create automation programs, or any other software tool, is itself a software program, whose creation, maintenance and further development involves considerable effort, because of the power of the functionality offered.

Until now, the development of such software tools has been largely characterized by multiple developments, i.e., a functionality which was required in the same or a similar manner for different software tools was implemented as a proprietary application for each software tool and was included as such in the respective software tool. This multiple development is disadvantageous, particularly with respect to the continuously increasing cost pressure. Furthermore, such various software tools are increasingly subject to requirements such as operational consistency and user management (usability) or display on a screen (layout).

In a few areas, however, software methods that allow multiple use of programming tools already exist for programming systems in automation. One example is a target system broker. A target system broker delegates the compilation of an automation program, which is created on an abstract programming model, as a function of the type of automation appliance onto which the automation program is intended to be loaded, to a corresponding compiler for generation of a specific automation program, which is matched to the respective automation appliance, based on a respective abstract automation program on which this is based.

### SUMMARY OF THE INVENTION

It is therefore an object of the invention to provide a software tool for automation and a method for creation of the software tool, which avoids the above-described disadvantages or is at least suitable for reducing their effects.

This and other objects and advantages are achieved in accordance with the invention by a software tool for automation having a functionality for output conversion in which the software tool allows a plurality of single domain applications, which are each intended for a dedicated object domain, to be combined at the same time, where each application comprises at least one first software interface for access to the output conversion, and where the output conversion comprises at least one mapping component for conversion of objects from an object domain of the application to an object of an abstract object model which is defined for the output component.

The term single-domain applications is also used in the following text. Here, the term single-domain application means an application is intended for conditioning and/or processing of objects of one and only one object domain. In the following text, a single-domain application is also referred to for short as simply “an application”. The software tool can be combined with a plurality of such applications, i.e., with at least one such application or two or more such applications. As a result, the functionality of the software tool can be extended dynamically by further functionality at any time, specifically by the functionality of the respective application that is or can be linked via the first software interface to the output conversion. This represents the major advantage of the invention.

The software tool therefore becomes an open and universal system, in which the user integrates the respectively required functionality, depending on the application situation. Depending on the number of such applications included, the software tool becomes a multidomain software tool. For the developer of such software tools, this results in the advantage that specific functionality, such as output functionality, need be implemented only once, and can be used repeatedly. Particularly when a specific output functionality is used repeatedly, this also results in a standard appearance for the outputs from widely differing functionalities of the software tool.

In an embodiment of the software tool, in addition to the first software interface, each application comprises at least one second software interface for access to database conversion and the database conversion comprises at least one mapping component or a plurality of mapping components for conversion of objects from the object domain of the application to an object of an object model that is defined for a data platform. Data of an application or of the individual applications of the software tool can then be stored in different formats in a respective data platform, for example, independently of the object domain in which the application is operating.

If the software tool comprises a plurality of applications of the type described here and in the following text, at the same time, i.e., of which each application is intended for one and only one object domain, this results in a multidomain software tool in which the support for a plurality of object domains is completely transparent for the user of the software tool.

In a method for operation of a software tool, as described here and in the following text, provision is made, when using an application that the software tool comprises or is integrated in the software tool, that for these objects and for objects that are applied to their object domains, each object is converted from an object domain of the application to an object of an abstract object model, which is defined for the output component, by use of the first software interface and calling up the output conversion through the first software interface.

In the case of a software tool in which the applications that are combinable in this way have the abovementioned first software interface and at the same time a second software interface, provision is made that, when using an application that the software tool comprises or is integrated in the software tool, for these objects and for objects which are applied to their object domains, each object is converted from an object domain of the application to an object of an object model, which is defined for a data platform, by use of the second software interface and calling up the database conversion through the second software interface.

The object of the invention is also achieved by a programming appliance, a personal computer, etc., which operates using the above-described method and in the following text and for this purpose comprises a device for implementing the method. Here, the invention is preferably implemented in software. The invention is therefore, on the one hand, also a computer program with program code instructions, which can be performed by a computer, for implementation of the method and, on the other hand, a memory medium having a computer program such as this and, finally, also an automation appliance, programming appliance or the like, in whose memory a computer program such as this is loaded or can be loaded as a way to performed the method and its embodiments. During operation of an appliance such as this, the computer program can be executed in a manner known per se by a processing unit, which the appliance comprises, in the form of a microprocessor.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

An exemplary embodiment of the invention will be explained in more detail in the following text with reference to the drawing. Mutually corresponding objects or elements are provided with the same reference symbols in all the figures, in which:

FIG. 1 is a simplified schematic block diagram of a basic structure of a software tool;

FIG. 2 shows is an embodiment of an software tool in accordance with the invention including a plurality of applications for implementation of different functions in the software tool, a first and second software interface of such applications for access to output conversion and/or database conversion, and an output component and a data platform;

FIG. 3 shows an exemplary embodiment of instances of object types of an abstract object model of an output component in accordance with the invention;

FIGS. 4-5 show exemplary embodiments of instances of object types of an abstract object model in accordance with the invention; and

FIG. 6 is a flow chart of the method in accordance with an embodiment of the invention.

### DETAILED DESCRIPTION OF THE PREFERRED EMBODIMENTS

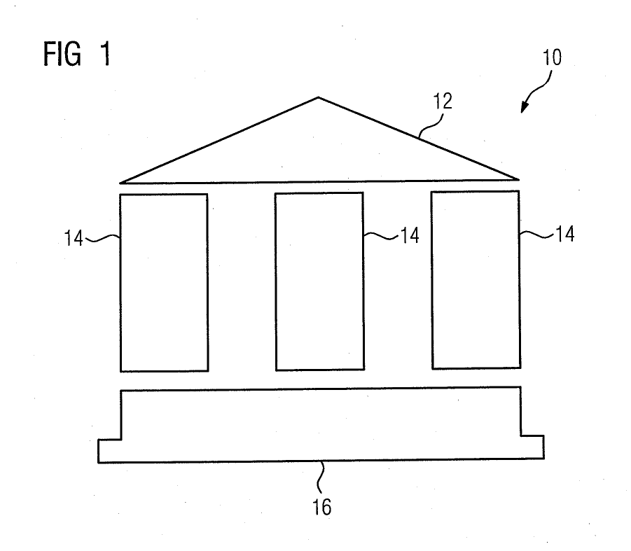

FIG. 1 shows, in a highly simplified schematic form, a software tool, i.e., an engineering system 10, including an application framework 12, at least one basic application 14 and a data management system 16 (data platform or database). Each basic application 14 provides, for example, a working area with one or more windows. The application framework 12 normally offers a menu with functions such as “insert object” or “delete object”, and tools, such as “zoom” or “switch grid network on/off”, for controlling the respective application, i.e., at least the basic application 14. Each basic application 14 manages its data with the aid of the data management system 16 to allow the data to be stored.

In comparison to the rigid concept illustrated in FIG. 1, in which a plurality of basic applications 14 may comprise a dedicated implementation of an intrinsically identical functionality, or functionality of the same type, the present invention provides an abstraction that is moved to a respective object domain that is intended to be processed by an application. Here, an object domain means a validity area of a predetermined or predeterminable set of objects or object types, i.e., a set of object types that covers a dedicated data linguistic area.

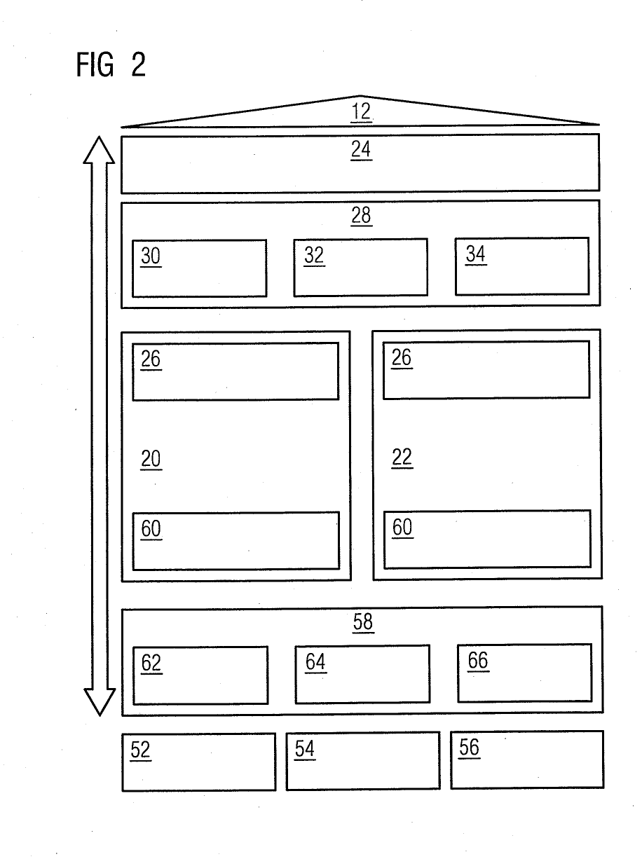

FIG. 2 illustrates this approach in a schematically simplified form. Instead of one basic application 14, or else in addition to a basic application 14 or a plurality of basic applications 14, the engineering system 10 (FIG. 1) comprises one or more single-domain applications 20, 22. A single-domain application 20, 22 is also referred to for short in the following text just as an application 20, 22. Two or more single-domain applications 20, 22 are illustrated for a user of a software tool equipped in this way. Such a multi-domain application. Such a plurality of single-domain applications 20, 22 is therefore completely transparent for the user, and the software tool is perceived to be a multi-domain software tool.

The engineering system 10 comprises an output component 24 (UI component), and each single-domain application 20, 22 serves this output component 24. Here, there is one and only one output component 24 for the single-domain application 20, 22, and this is used jointly by all or at least a plurality of the single-domain applications 20, 22. The output component 24 is based on an abstract object model (UI object model), which is defined separately from specific object domains. The abstract object model of the output component 24 is normally restricted to graphics character objects.

For access to the output component 24, each single-domain application 20, 22 comprises a software interface (first software interface 26) intended for this purpose. This first software interface 26 allows access to a functionality that is referred to in the following text as output conversion 28 (mapper). The output conversion 28 maps objects from the object domains of the respective application 20, 22 into the object model of the output component 24. One special feature of this output conversion 28, i.e., a corresponding software tool functionality that is implemented in software, is that any desired number of object domains can be supported and that mapping to the object model of the output component 24 is performed for each supported object domain. For this purpose, the output conversion 28 comprises an appropriate plurality of mapping components 30, 32, 34, with each mapping component 30, 32, 34 allowing conversion of objects from at least one object domain to the object model of the output component 24.

The disclosed embodiment in accordance with the invention will be explained in the following text using the example of a circuitry editor as a multidomain situation. A simple circuitry editor draws boxes, connectors and graphic connecting lines between the connectors.

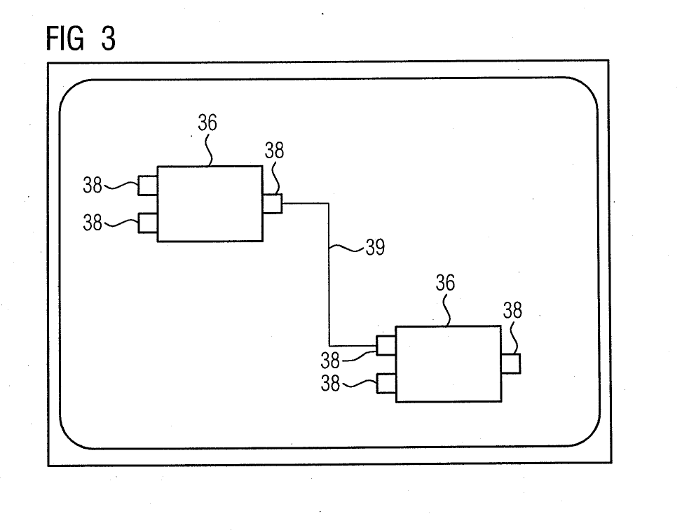

An abstract object model of the output component 24 therefore comprises (in a UI object model) at least the three following object types: small graphic box 36, graphic connector 38 and graphic connecting line 39. FIG. 3 shows an illustration of instances of such object types.

A distinction is drawn between the following two domain models in the example based on the circuitry editor: data flow model and signal flow model. One and only one dedicated application 20, 22 (FIG. 2) is provided as a single-domain application for each domain model.

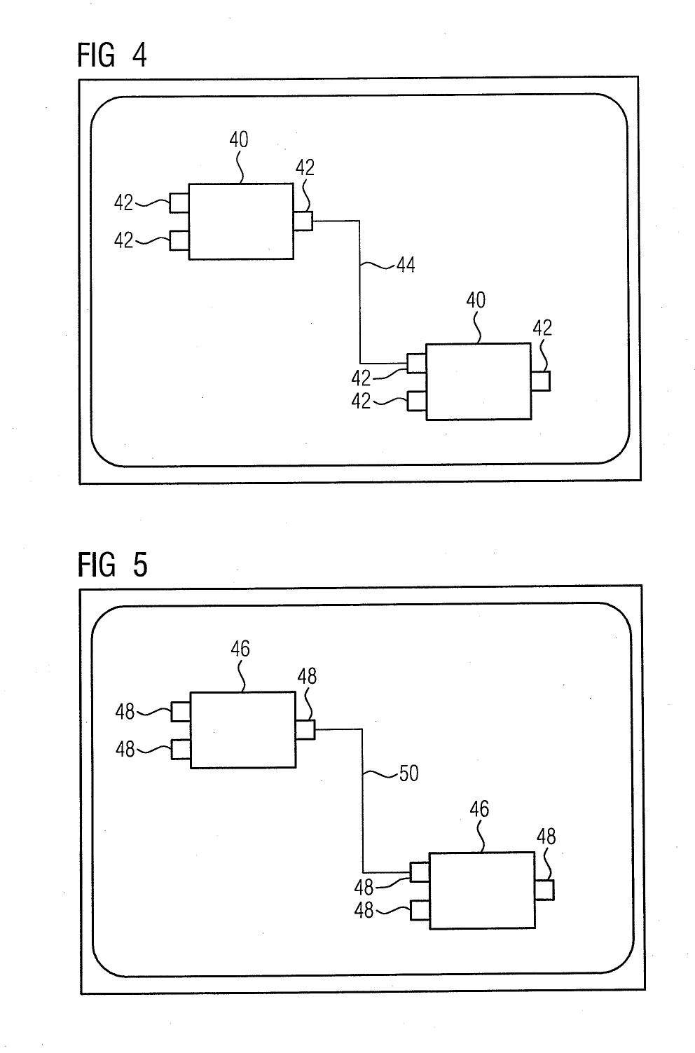

The data flow model is based on an object domain having at least the three following object types (FIG. 4): data module 40, data module element 42 and data assignment 44. The data flow model can be used for engineering systems for automation and, in this case, specifically for development environments for creation of automation programs based on specific programming languages for automation, such as FUP or CFC.

The signal flow model is based on an object domain having at least the three following object types (FIG. 5): single control unit 46 (for example, valve, motor or regulator), control variable/process variable 48 (for example, rotation speed or valve closed) and signal link 50. The signal flow model can likewise be used for engineering systems for automation and in this case specifically for development environments for creation of signal flowcharts based on process Standards or Norms.

Here, the two domain models “data flow” and “signal flow”, for example, are supported by two appropriate mapping components 30, 32, 34 of the output conversion 28.

A functionality of a first such mapping component 30 for conversion of objects from the object domain “data flow” to the object model of the output component 24 is describable by the software implementation of the following associations:
Small graphic box <--> data module
Graphic connector <--> data module element
Graphic connecting line <--> data assignment.

A functionality of a second such mapping component 32 for conversion of objects from the object domain “signal flow” to the object model of the output component 24 is correspondingly describable by the software implementation of the following associations:
Small graphic box <--> individual control unit
Graphic connector <--> control variable/process variable
Graphic connecting line <--> signal link.

However, it should be noted that, in the examples chosen here, the situation in which each model comprises three and only three object types occurs only randomly. For other object domains, there may be a greater or lesser number of object types, and correspondingly an n-m association. A Lookup-Table (LUT) or the like may be used for implementation of the associations or dependency relationships just described.

An (instantiated) object of the respective object domain that is used for an application 20, 22 and in its object domain is still provided with an identification that indicates the respective basic object type, i.e., for example, the object type for a data module 40. This may be identified numerically, alphanumerically or in some other suitable manner. Here, without loss of more extensive generality, it is assumed that the identification is alphanumeric and comprises, in each case in clear text, the names of the object types as already mentioned above, i.e., for example, “data module”, “data module element” and “data assignment”. The data on which the illustration in FIG. 4 is based could accordingly appear as follows:

```
DB1 ( = “data module”)
    INPUT:
        I1 ( = “data module element”)
        I2 ( = “data module element”)
    OUTPUT
        O1 ( = “data module element”)
DB2 ( = “data module”)
    INPUT:
        I1 ( = data module element”)
        I2 ( = data module element”)
    OUTPUT
        O1 ( = “data module element”)
C ( = “data assignment”)
    START
        DB1, 01
    END
        DB2, I1
```

Here, for the interpretation of data such as this, the first mapping component 30 can, based on the identifications, which comprise clear text according to the example, of the objects (i.e., the identifications of the object types upon which the objects are based), select the respectively appropriate association, such as by searching for the corresponding identification in an LUT, and by identifying the object associated with this identification in the object model of the output component 24. In order to represent the object referred to as “DB1” based on the object type “data module”, the functionality that is associated with the object type “small box” in the object model of the output component 24 can then be called up and implemented. This principle applies in a corresponding manner to all other objects and the respective object types on which they are based. Furthermore, this principle also applies in a corresponding manner to other (source) object domains, i.e., in this case also the object domain “signal flow model”, for example.

Every application 20, 22 comprises a first software interface 26 for access to the output conversion 28. As a result, the entire software tool, i.e., the engineering system 10 (FIG. 1), can have further applications 20, 22 added to it at any time, in order to provide additional functionality. In the same way, in principle, the output conversion 28 can also be extended at any time by adding additional mapping components 30.

For data maintenance, i.e., for loading and for storing objects that are used for an application 20, 22 in its object domain, a conversion is likewise provided in the embodiment illustrated in FIG. 2. This allows conversion of the data from and to a format for widely differing data platforms 52, 54, 56. A data platform 52, 54, 56 allows software, checking or manipulating access to a database, i.e., a databank. A data platform 52, 54, 56 therefore comprises or has at least access to a databank that is not shown separately.

Every application 20, 22 has a second software interface 60 to call up a functionality that is referred to in the following text as database conversion 58 and by which this conversion is implemented. The database conversion 58 comprises one or more mapping components 62, 64, 66, whose functionality with respect to the aspect of conversion of objects from an object domain to objects of a data platform in principle corresponds to the functionality of the mapping components 30, 32, 34 of the output conversion 28. An object in the respective object domain of the application 20, 22 is therefore converted to a corresponding object corresponding to the respective object model of the data platform 52, 54, 56, and an object in the respective object model of the data platform 52, 54, 56 is therefore converted to a corresponding object in the respective object domain of the application 20, 22. In order to store objects of the object domains of the respective application 20, 22, these are converted to the object model of the data platform 52, 54, 56 and are transferred to the data platform 52, 54, 56, thus allowing storage to be performed directly. In order to load objects from a data platform 52, 54, 56 into the object domain of the respective application 20, 22, the appropriate data is first of all called up from the data platform 52, 54, 56, and it is then converted from the object model of the data platform 52, 54, 56 to the object model of the application 20, 22.

Furthermore, the database conversion 58 with its mapping components 62, 64, 66 is also particularly suitable for a changeover to modified data storage for new software generations. Old data formats and one or more data formats that may be added with a new software generation can be supported with the database conversion 58 and respective mapping components 62, 64, 66.

The components that are covered by the block arrow illustrated at the side in FIG. 2 allow integration in an engineering system 10 (FIG. 1) or the like, by the respective components effectively being inserted between the application framework 12 and the data management system 16.

Individual primary aspects of the description provided here can therefore be summarized briefly as follows: the approach according to the invention makes it possible to extend a software tool for automation dynamically by adding additional applications 20, 22. All such applications 20, 22 jointly use one output component 24, whose functionality is included only once, in a corresponding manner by the software tool (in contrast to a previously at least partially existing implementation of such functions in every application covered by a software tool with output functionality). If a user of the software tool requires further functionality at a later time, he receives or purchases a further application 20, 22 which, using its first software interface 26 or its first and second software interfaces 26, 60, directly accesses the output conversion 28 or the output and database conversion 28, 58, thus allowing integration in the software tool without any problems.

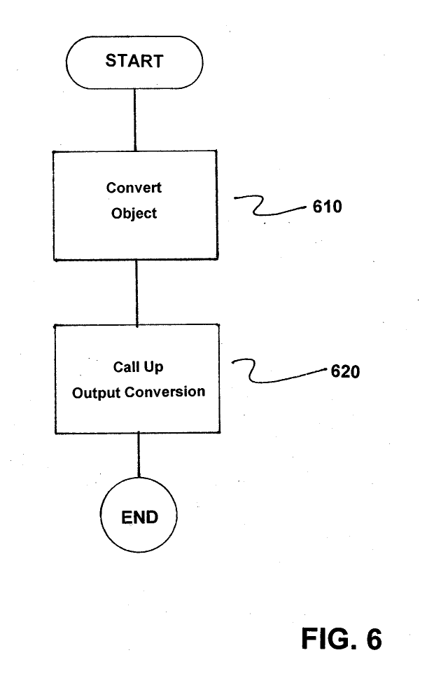

FIG. 6 is a flow chart of a method for operating a software tool, where the software tool includes a functionality for output conversion and comprises a plurality of applications, each of the plurality of applications is configured for a dedicated object domain and is simultaneously combinable with the software tool, where each of the plurality of applications comprises at least one first software interface for access to the output conversion, and where the output conversion comprises at least one mapping component configured to convert objects from the object domains of the applications to respective objects of an abstract object model defined for the output component. The method comprises converting, using a processor, one object of the object domain of at least one of the applications to an object of the abstract object model defined for the output component using the first software interface, as indicated in step 610. The output conversion is subsequently called up, using the processor, via the software interface, as indicated in step 620.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A software tool for automation having a functionality for output conversion, comprising:
a plurality of applications, each of said plural applications being configured for a dedicated object domain and being simultaneously combinable with the software tool;
wherein each of said plural applications comprises at least one first software interface for access to the output conversion; and
wherein the output conversion comprises at least one mapping component configured to convert objects from the object domains of the applications to respective objects of an abstract object model defined for the output component.

2. The software tool as claimed in claim 1, wherein each of said plural applications comprises at least one second software interface configured to access a database conversion, and wherein the database conversion comprises at least one mapping component configured to convert objects from the object domains of the applications to respective objects of an object model defined for a data platform.

3. The software tool as claimed in claim 1, wherein each of said plural applications is configured for only one respective object domain.

4. The software tool as claimed in claim 2, wherein each of said plural applications is configured for only one respective object domain.

5. A method for operating a software tool, wherein the software tool includes a functionality for output conversion and comprises a plurality of applications, each of said plural applications being configured for a dedicated object domain and being simultaneously combinable with the software tool, wherein each of said plural applications comprises at least one first software interface for access to the output conversion, and wherein the output conversion comprises at least one mapping component configured to convert objects from the object domains of the applications to respective objects of an abstract object model defined for the output component, the method comprising:
converting, using a processor, one object of the object domain of at least one of the applications to an object of the abstract object model defined for the output component using the first software interface; and
calling up, using the processor, the output conversion via the software interface.

6. The method as claimed in claim 5, wherein each of said plural applications comprises at least one second software interface configured to access a database conversion, and wherein the database conversion comprises at least one mapping component configured to convert objects from the object domains of the applications to respective objects of an object model defined for a data platform, the method further comprising:
converting, using the processor, one object of the object domain of at least one of the applications to an object of the object model defined for the data platform using the second software interface; and
calling up the database conversion using the second software interface.

7. A process in which a computer executes instructions set forth in a computer program executing on a processor which, when used on the computer, causes operation of a software tool, wherein the software tool includes a functionality for output conversion and comprises a plurality of applications, each of said plural applications being configured for a dedicated object domain and being simultaneously combinable with the software tool, wherein each of said plural applications comprises at least one first software interface for access to the output conversion, and wherein the output conversion comprises at least one mapping component configured to convert objects from the object domains of the applications to respective objects of an abstract object model defined for the output component, the computer program comprising computer executable instructions including:
program code for converting, using the processor, one object of the object domain of at least one of the applications to an object of the abstract object model defined for the output component using the first software interface; and
program code for calling up, using the processor, the output conversion via the software interface.

8. An automation appliance having a memory in which the computer program as claimed in claim 7 is loaded.

9. A non-transitory computer-readable memory medium encoded with a computer program executable by a computer which causes operation of a software tool, wherein the software tool includes a functionality for output conversion and comprises a plurality of applications, each of said plural applications being configured for a dedicated object domain and being simultaneously combinable with the software tool, wherein each of said plural applications comprises at least one first software interface for access to the output conversion, and wherein the output conversion comprises at least one mapping component configured to convert objects from the object domains of the applications to respective objects of an abstract object model defined for the output component, the computer program comprising computer executable instructions including:
program code for converting, using the processor, one object of the object domain of at least one of the applications to an object of the abstract object model defined for the output component using the first software interface; and
program code for calling up, using the processor, the output conversion via the software interface.
